(19) United States
(12) Patent Application Publication
(10) Pub. No.: US 2012/0168371 A1
(43) Pub. Date: Jul. 5, 2012

(54) Water filter cartridge and method of manufacturing same

(76) Inventor: Han-Tang Fu, Taipei (TW)

(21) Appl. No.: 12/983,896

(22) Filed: Jan. 4, 2011

(51) Int. Cl. B01D 39/06; B82Y 30/00

(52) U.S. Cl. 210/503; 977/902

(57) ABSTRACT

A filter cartridge and method of manufacturing same is provided. The filter cartridge of a drinking water filter includes a plurality of nanometer sized grains each comprising a core including a granulated mixture, ceramic soil surrounding the mixture, and a plurality of holes formed within the ceramic soil and on a surface thereof wherein the mixture includes tourmaline powder, mica powder, mineral powder, germanite powder, calcite powder, amber powder, agate powder, actinolite powder, crystal powder, and jade powder; and a nanometer sized silver layer coated on the core. The silver layer includes a plurality of through holes.

### BACKGROUND OF THE INVENTION

1. Field of Invention

The invention relates to water filter cartridges and more particularly to a water filter cartridge and method of manufacturing same.

2. Description of Related Art

It is estimated tat over one billion people worldwide lack access to clean drinking water. Water-borne diseases are one of the leading causes of disease and death in the world. Many water systems fail due to complexity of operations, costs, expense, inconvenient use, not portable, and requiring chemicals and energy. Industries are seeking sustainable cost effective water supply systems to provide water to their facilities. In dealing with water scarcity, there is an increasing demand for rain water and industrial wastewater filtration and recycling using sustainable systems that do not rely on additional chemical treatment or extensive maintenance. There are many different approaches to providing clean drinking water such as filtration, ultra filtration, UV (ultra violet) oxidation, and chemical disinfection. These approaches typically address only parts of the needs for water purification.

There is a commercially available type of water filter including a cylindrical hollow filter cartridge having multiple filter pads, a layer of granulated zinc and copper alloy, a layer of granulated activated carbon, a layer of ion-exchange resin, and a layer of granulated calcite.

Materials for manufacturing filter cartridge of above typical water filter do not disclose the unique features and advantages of the subject materials for manufacturing filter cartridge of drinking water filter used with a tap water supply as described herein. Thus, the need for improvement exists.

### SUMMARY OF THE INVENTION

It is therefore one object of the invention to provide a filter cartridge of a drinking water filter comprising a plurality of nanometer sized grains each comprising a core including a granulated mixture, ceramic soil surrounding the mixture, and a plurality of holes formed within the ceramic soil and on a surface thereof wherein the mixture includes tourmaline powder, mica powder, mineral powder, germanite powder, calcite powder, amber powder, agate powder, actinolite powder, crystal powder, and jade powder; and a nanometer sized silver layer coated on the core, the silver layer including a plurality of through holes.

The above and other objects, features and advantages of the invention will become apparent from the following detailed description taken with the accompanying drawings.

### BRIEF DESCRIPTION OF THE DRAWINGS

FIG. 1 is a flow chart illustrating a method of manufacturing a water filter cartridge according to the invention;

FIG. 2 is a perspective view of one of grains of a filter cartridge according to the invention;

FIG. 3 is a cross sectional view of the grain of FIG. 2;

FIG. 4 is an enlarged view of the core of FIG. 3 with the silver layer removed; and

FIG. 5 is a schematic longitudinal sectional view of a water filter incorporating the filter cartridge of the invention.

### DETAILED DESCRIPTION OF THE INVENTION

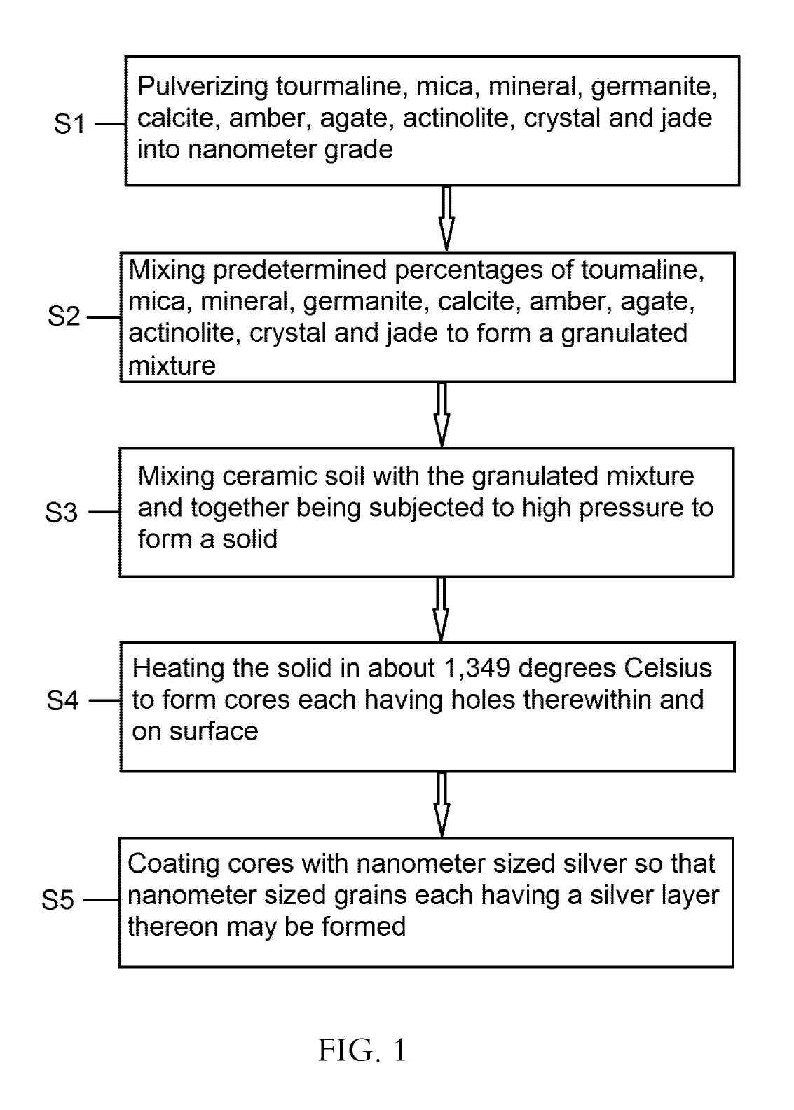

Referring to FIG. 1, a method of manufacturing a water filter cartridge of a drinking water filter in accordance with the invention is illustrated below. The method comprises the following steps:

Step S1: Materials including tourmaline, mica, mineral, germanite, calcite, amber, agate, actinolite, crystal, and jade are pulverized into nanometer grade.

Step S2: Weight percentage about 8 percent of tourmaline powder, weight percentage about 12 percent of mica powder, weight percentage about 16 percent of mineral powder, weight percentage about 4 percent of germanite powder, weight percentage about 9 percent of calcite powder, weight percentage about 8 percent of amber powder, weight percentage about 10 percent of agate powder, weight percentage about 12 percent of actinolite powder, weight percentage about 15 percent of crystal powder, and weight percentage about 6 percent of jade powder are uniformly mixed and cooled to form a granulated mixture 42.

Step S3: Ceramic soil 41 is mixed with the mixture 42 and together is subjected to a predetermined high pressure to form a solid.

Step S4: Heat the solid in a temperature of about 1,349 degrees Celsius to form a plurality of cores 3 each having a plurality of holes 31 therewithin and on surface.

Step S5: Coat the surfaces of the cores 3 with nanometer sized silver so that a plurality of nanometer sized grains 1 each having a nanometer sized silver layer 2 with a plurality of through holes 21 may be formed.

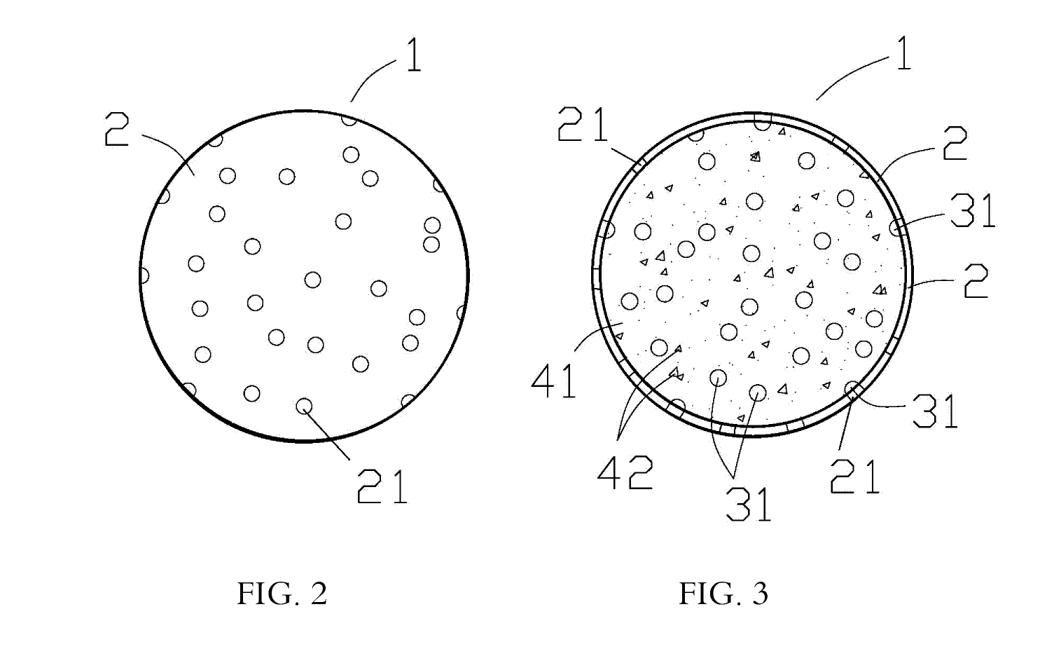

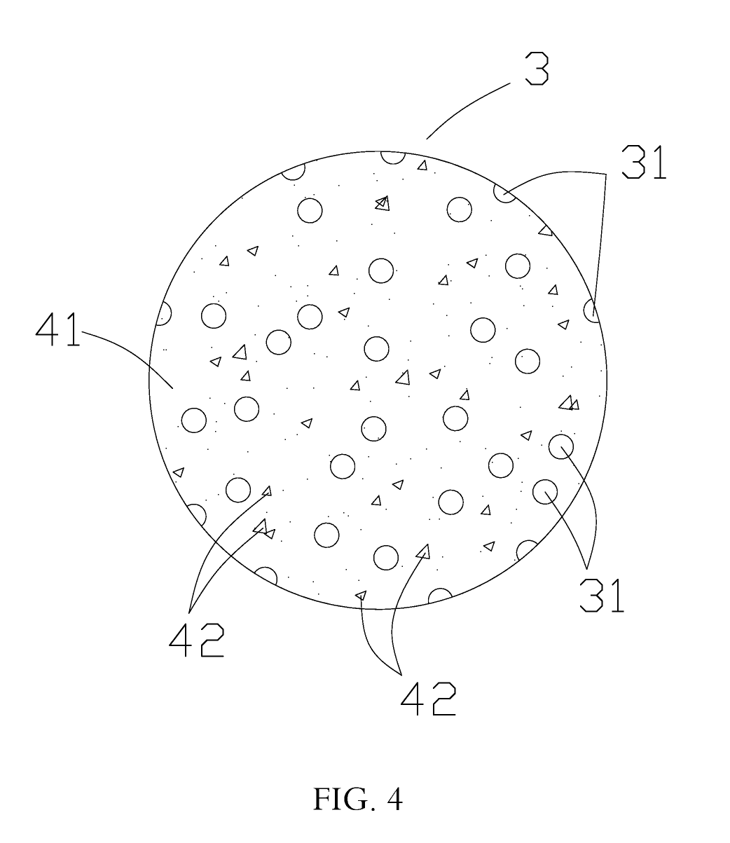

Referring to FIGS. 2 to 5, a filter cartridge for a drinking water filter 5 in accordance with the invention is shown. The filter cartridge comprises a plurality of nanometer sized grains 1 as detailed below.

The spherical grain 1 comprises a core 3 including a granulated mixture 42, ceramic soil 41 surrounding the mixture 42, and a plurality of holes 31 formed within the ceramic soil 41 and on a surface thereof. The mixture 42 comprises tourmaline powder, mica powder, mineral powder, germanite powder, calcite powder, amber powder, agate powder, actinolite powder, crystal powder, and jade powder. The grain 1 further comprises a nanometer sized silver layer 2 coated on the core 3. The silver layer 2 has a plurality of through holes 21.

Prefereably, the mixture 42 comprises weight percentage about 8 percent of tourmaline powder, weight percentage about 12 percent of mica powder, weight percentage about 16 percent of mineral powder, weight percentage about 4 percent of germanite powder, weight percentage about 9 percent of calcite powder, weight percentage about 8 percent of amber powder, weight percentage about 10 percent of agate powder, weight percentage about 12 percent of actinolite powder, weight percentage about 15 percent of crystal powder, and weight percentage about 6 percent of jade powder.

It is envisaged by the invention that unfiltered water can pass the through holes 21 of the silver layer 2 into the holes 31 of the core 3 with its impurities being contained by both the silver layer 2 and the core 3 so that filtered water with sparking clarity can be obtained when leaving the grains 1.

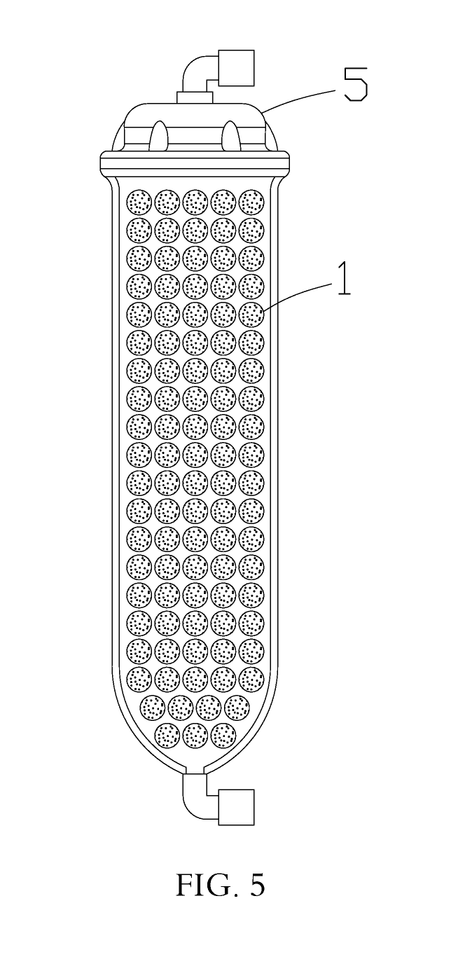

As shown in FIG. 5 specifically, the filter cartridge 1 can be mounted in the drinking water filter 5 which is substantially shaped as a cylinder having upper and lower ends as inlet and outlet respectively.

While the invention has been described in terms of preferred embodiments, those skilled in the art will recognize that the invention can be practiced with modifications within the spirit and scope of the appended claims.

What is claimed is:

1. A filter cartridge of a drinking water filter comprising:
a plurality of nanometer sized grains each comprising:
a core including a granulated mixture, ceramic soil surrounding the mixture, and a plurality of holes formed within the ceramic soil and on a surface thereof wherein the mixture includes tourmaline powder, mica powder, mineral powder, germanite powder, calcite powder, amber powder, agate powder, actinolite powder, crystal powder, and jade powder; and
a nanometer sized silver layer coated on the core, the silver layer including a plurality of through holes.

2. The filter cartridge of claim 1, wherein the mixture comprises weight percentage about 8 percent of tourmaline powder, weight percentage about 12 percent of mica powder, weight percentage about 16 percent of mineral powder, weight percentage about 4 percent of germanite powder, weight percentage about 9 percent of calcite powder, weight percentage about 8 percent of amber powder, weight percentage about 10 percent of agate powder, weight percentage about 12 percent of actinolite powder, weight percentage about 15 percent of crystal powder, and weight percentage about 6 percent of jade powder.
